(19) United States
(12) Patent Application Publication
(10) Pub. No.: US 2006/0123764 A1
(43) Pub. Date: Jun. 15, 2006

(54) Adjustable windrower shields

(76) Inventors: Kenneth W. McLean, New Holland, PA (US); Robert L. Rice, New Holland, PA (US); Donald L. Osborne, Quarryville, PA (US); Roger D. Huggard, Lancaster, PA (US)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 11/008,012

(22) Filed: Dec. 9, 2004

(51) Int. Cl. A01D 43/02

(52) U.S. Cl. 56/350

(57) ABSTRACT

Windrow shields that pivot adjacent the forward ends thereof into and out of the path of crop material to control the width of the windrow. An electric motor and linkage to the shields allows the special relationship between the shields to be adjusted on-the-go from the operator's location.

### BACKGROUND OF THE INVENTION

The present invention relates generally to agricultural self-propelled windrowers, and more particularly to adjustable windrow shields for such machines.

Windrowers have been used in farming operations for several decades. Generally, windrowers are designed to cut and process hay and other crops and to selectively deposit the crop on the ground in either a windrow or a swath. More specifically, a windrower of the type under consideration here includes a tractor and a separate header. The tractor has a pair of drive wheels on the forward end and a pair of pair of caster wheels on the rear end. The wheels support a main frame that carries the engine between the wheel pairs, and a drive train. A cab provides an enclosed environmentally controlled operator's platform generally above the drive wheels. A variety of crop-harvesting headers are selectively attachable to the forward end of the unit to provide the operator with a choice of tools with which to handle the crops.

Both pull-type and self-propelled windrowers are typically provided with both manually adjustable swathboards and windrow shields that allow the selective formation of either windrows or swaths. Swathboards are located sometimes on the header and sometimes on the main frame behind the conditioning mechanism. Such shields are located behind the conditioning mechanism of the machine, generally in the flow path of the crop materials as they are discharged rearwardly through the air by the conditioning mechanism. Thus, if the swathboard is lowered into the flow of crop materials, and the windrow shields are opened, a broad swath is deposited on the ground. If, on the other hand, the swathboard is raised and the windrow shields are pivoted inwardly, the crop stream is converged into an adjustable-width windrow. The adjustment of windrow width is normally manually accomplished by the operator, who must leave the operator's position and approach the rear of the machine.

It would be a significant advantage to develop an improved windrow shield adjustment mechanism that permits the operator to adjust the windrow width from the operator's position while the windrower is in operation.

### SUMMARY OF THE INVENTION

Accordingly, it is an object of the present invention is to provide an adjustable windrow shield for a self-propelled windrower.

Another object of the present invention is to provide an electrically adjustable windrow shield.

It is another object of the instant invention to provide an electrically adjustable windrow shield allowing the operator to change the width of the windrow being formed and control the drying speed of the crop.

Yet another object of the present invention is to provide windrow shields affixed to linkage and an electric motor, making the shields adjustable on-the-go by the activation of a switch on a console at the operator's location.

It is yet another object of this invention to provide windrow shields that pivot adjacent the forward ends thereof, under the direction of a linear actuator, to adjust the width of the windrow while the windrower is moving.

These and other objects are attained by providing windrow shields that pivot adjacent the forward ends thereof into and out of the path of crop material to control the width of the windrow. An electric motor and linkage to the shields allows the special relationship between the shields to be adjusted on-the-go from the operator's location.

### DESCRIPTION OF THE DRAWINGS

The advantages of this invention will be apparent upon consideration of the following detailed disclosure of the invention, especially when taken in conjunction with the accompanying drawings wherein:

FIG. 1 is a side plan view of a windrower, with header, showing the header and crop conditioning mechanism, but not the windrow shields;

FIG. 2 is partial rear view of the windrower of FIG. 1, without header, showing the windrow shields in fully open locations;

FIG. 3 is a partial top view of the shields and control components thereof;

FIG. 4 is a partial top view, similar to FIG. 3, of the shields and control components in the fully open position; and

FIG. 5 is a partial schematic view of the linear actuator and the electrical controls therefore.

### DESCRIPTION OF THE PREFERRED EMBODIMENT

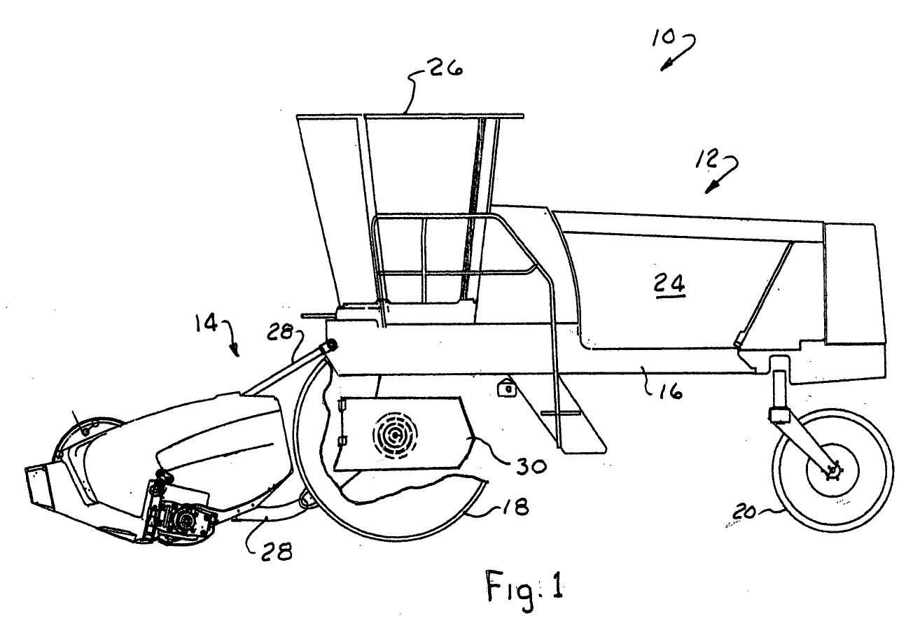

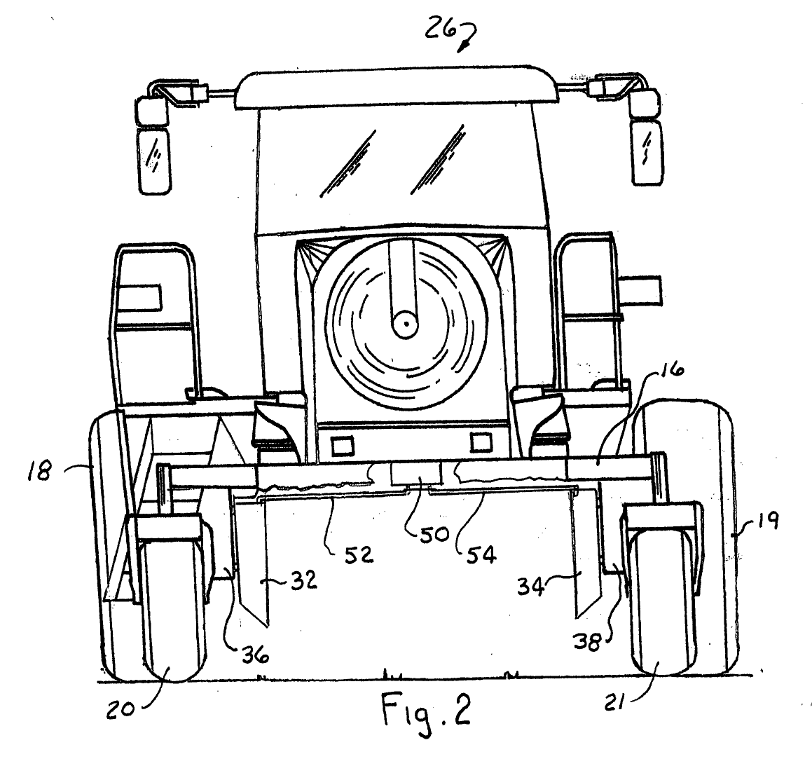

FIG. 1 shows the two primary components of a self-propelled windrower 10, i.e., tractor 12 and header 14. Tractor 12 has a main frame 16, with a longitudinal horizontal axis from front to back, that is supported by a pair of drive wheels 18, 19 (see FIG. 2 for both wheels) on the forward portion thereof and a pair of rear wheels 20, 21 (see FIG. 2 for both wheels) adjacent the rear end. An engine, located under cowling 24, a transmission and other components, all well known in the art, are supported on the main frame 16 and provide the power necessary for the machine to operate. A cab 26, also supported on the main frame, encloses the operator's platform to provide an environmentally controlled location from which the windrower may be comfortably operated.

Header 14 may be of several designs, but typically comprises a cutting mechanism, either a sicklebar or rotary cutter, a feeder mechanism and conditioning rolls. The header is supported by a hydraulic lift and flotation structure 28 that may be activated to selectively raise or lower the header between transport and operational positions. Positioned below cab 26 and behind header 14 is a conditioning mechanism 30 (shown only in FIG. 1) of well known construction. Normally, mechanism 30 is comprised of two elongate rolls transverse to the general direction of travel of the windrower and adjustable in their relative spacing. Crop materials cut by the header are directed rearwardly into the conditioning mechanism where the stems of the crop are crushed. From there, the crop material is expelled rearwardly in a general mat of material that ends up on the ground where it dries prior to further processing or packaging.

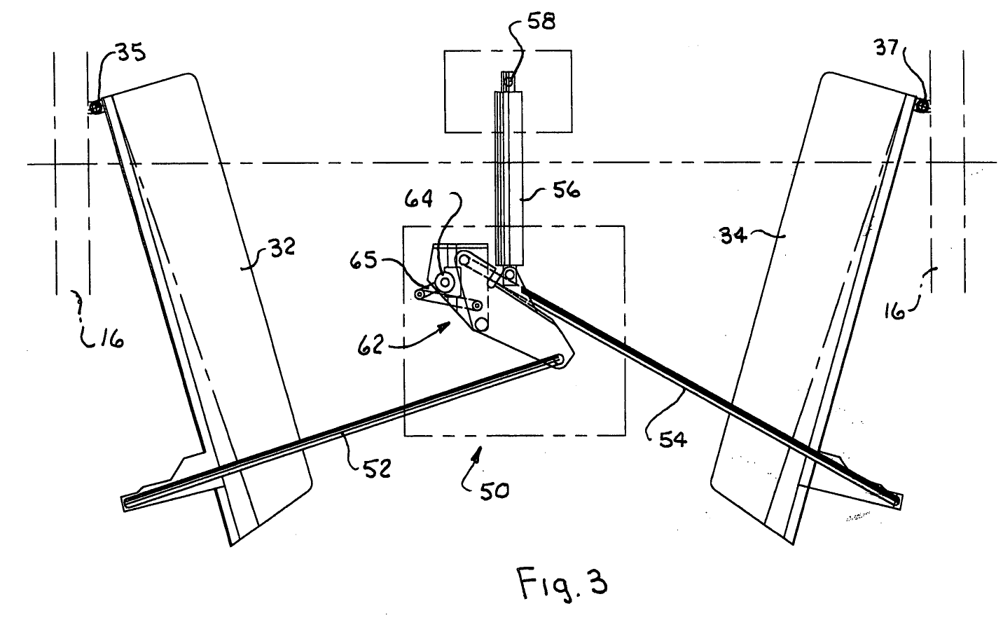

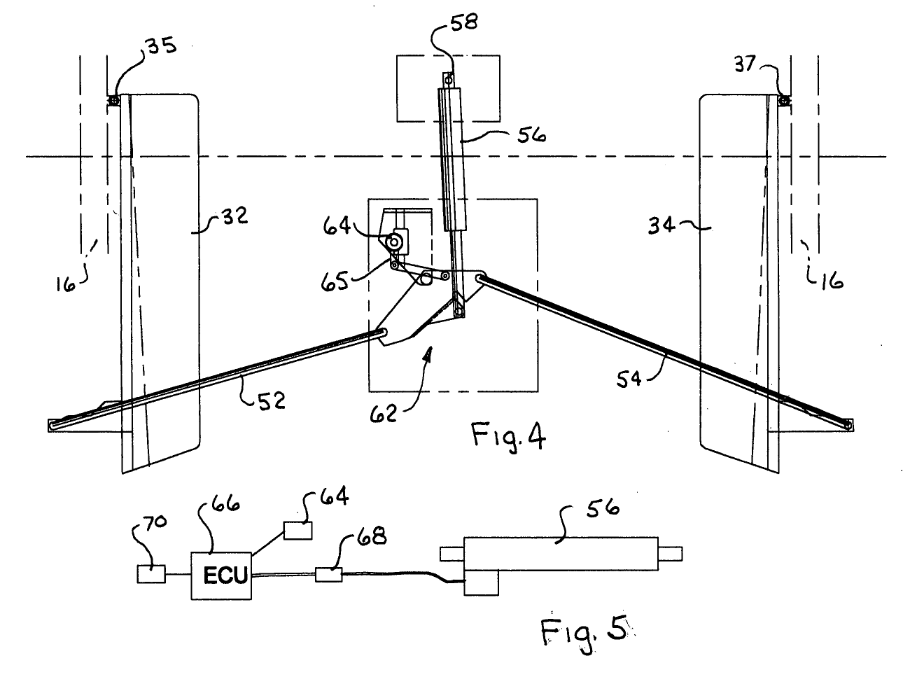

FIG. 2 further shows two mirror image windrow shields 32, 34 at either side of the vertically pivotably affixed along vertical axes 35, 37 to sub-frame members 36, 38, themselves affixed to main frame 16. FIG. 2 also depicts the shield movement mechanism 50 and the transfer rods 52, 54 pivotably connected at one end to mechanism 50 and to the respective shields at the other. Referring now to FIGS. 3 and 4, it can be seen that an electric motor (or linear actuator) 56 is pivotably connected at one end to frame member 60 and at the other end to bell crank 62 that rotates transfer rods 52, 54 to pivot the shields either toward or away from each other, changing the width of the windrow.

In FIG. 5 it is seen that electric motor 56 is electrically connected to an electronic control unit (ECU) 66 through a three position rocker switch 68. In the first position, the motor extends its ram to increase the distance between shields, while in the second position the ram is shortened to decrease the distance. The third position is neutral. Potentiometer 64, connected to bell crank 62 by linkage 65 provides a voltage value to ECU 66, representing the relative positions of the two shields. ECU 66 visually displays this information in the form of a bar graph on a console 70 located at the operator's position, normally within the cab.

While the adjustable windrow shields are described herein as being incorporated in a self-propelled windrower, one skilled in the art will readily understand that pull-type windrowers could also benefit from this improvement.

It will be understood that changes in the details, materials, steps and arrangements of parts which have been described and illustrated to explain the nature of the invention will occur to, and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the inventions. Accordingly, the following claims are intended to protect the invention broadly as well as in the specific form shown.

1. An agricultural windrower with a longitudinal axis extending between front and opposing rear ends, front and rear wheel pairs supporting a main frame, each wheel of said wheel pairs spaced apart on opposing sides of said longitudinal axis and forming a general crop flow channel therebetween, an engine and drive system supported by said main frame to supply motive power to said front wheel pair, said main frame adapted to support a removable transverse crop-engaging header on said front end thereof to cut standing crop and convey it rearwardly into a crop conditioning mechanism depending from said main frame and then into said crop flow channel, and a windrower width control system comprising:
first and second elongate generally planar shields, each having a front end and an opposing rear end;
first and second generally vertical sub-frame members affixed to and extending downwardly from said main frame, one adjacent each side of said crop flow channel;
respective said front ends of said shields vertically pivotably affixed to respective said sub-frame members such that said rear ends of said shields may move horizontally toward and away from each other into and out of said crop flow channel;
a shield movement mechanism including an electric motor supported by said main frame and connected to each said shield; and
an electric control unit electrically connected to said motor and including a switch to activate said motor and selectively move said rear ends of said shields toward and away from each other.

2. The windrower of claim 1, further including:
a potentiometer connected to said shield movement mechanism and said electronic control unit such that movement of said shields results in a voltage value change in said potentiometer that is read by said electronic control unit; and
said electronic control unit including a visual readout representative of said change in voltage value.

3. The windrower of claim 2, wherein:
said visual readout is in the form of a bar graph.

4. The windrower of claim 3, wherein:
said shield movement mechanism further includes a bell crank affixed to said electric motor.

5. The windrower of claim 4, wherein:
said potentiometer is connected to said bell crank.

6. The windrower of claim 1, wherein:
said shield movement mechanism further includes a bell crank affixed to said electric motor.

7. The windrower of claim 6, wherein:
a potentiometer connected to said movement mechanism and said electronic control unit such that movement of said shields results in a voltage value change in said potentiometer that is read by said electronic control unit; and
said electronic control unit including a visual readout representative of said change in voltage value.

8. The windrower of claim 7, wherein:
said potentiometer is connected to said bell crank.

9. The windrower of claim 8, wherein:
said visual readout is in the form of a bar graph.

10. The windrower of claim 9, wherein:
said respective rear ends of said shields are pivotally connected to said bell crank by first and second transfer rods.

11. In an agricultural windrower with a longitudinal axis extending between front and opposing rear ends, front and rear wheel pairs supporting a main frame, each wheel of said wheel pairs spaced apart on opposing sides of said longitudinal axis and forming a general crop flow channel therebetween, an engine and drive system supported by said main frame to supply motive power to said front wheel pair, said main frame adapted to support a removable transverse crop-engaging header on said front end thereof to cut standing crop and convey it rearwardly into a crop conditioning mechanism depending from said main frame and then into said crop flow channel, and a windrower width control system, the improvement comprising:
first and second elongate generally planar shields, each having a front end and an opposing rear end;
first and second generally vertical sub-frame members affixed to and extending downwardly from said main frame, one adjacent each side of said crop flow channel;
respective said front ends of said shields vertically pivotably affixed to respective said sub-frame members such that said rear ends of said shields may move horizontally toward and away from each other into and out of said crop flow channel;
a shield movement mechanism including an electric motor supported by said main frame and connected to each said shield;
an electric control unit electrically connected to said motor and including a switch to activate said motor and selectively move said rear ends of said shields toward and away from each other, and
a potentiometer connected to said shield movement mechanism and said electronic control unit such that movement of said shields results in a voltage value change in said potentiometer that is read by said electronic control unit;
said electronic control unit including a visual readout representative of said change in voltage value.

12. The windrower of claim 11, further including;
said shield movement mechanism further includes a bell crank affixed to said electric motor and said potentiometer is connected to said bell crank.

13. The windrower of claim 12, wherein:
said visual readout is in the form of a bar graph.

14. The windrower of claim 13, wherein:
said respective rear ends of said shields are pivotably connected to said bell crank by first and second transfer rods.

15. An agricultural windrower for movement across a field of standing crop material in a direction of travel defining a forward direction, said windrower comprising:
an elongate wheel-supported main frame extending generally transverse to said direction of travel;
a crop cutting mechanism affixed to the front of said main frame and extending transversely to said direction of travel, said cutting mechanism engaging the cut crop and moving it rearwardly;
said main frame having a rear end opposing said front end;
a crop conditioning mechanism affixed to said rear end of said main frame, said conditioning mechanism aligned with said cutting mechanism to receive cut crop therefrom, conditioning said crop and moving it rearwardly in a mat of crop channel and depositing it on the ground behind the windrower, said mat having a width similar to that of the crop conditioning mechanism;
first and second elongate generally planar shields, each having a front end and an opposing rear end;
respective said front ends of said shields vertically pivotably affixed to respective said main frame adjacent each side of said crop conditioning mechanism and extending rearwardly such that said rear ends of said shields may move horizontally toward and away from each other;
a shield movement mechanism including an electric motor supported by said main frame and connected to each said shield; and
an electric control unit electrically connected to said motor and including a switch to activate said motor and selectively move said rear ends of said shields toward and away from each other.

16. The windrower of claim 15, wherein:
a potentiometer connected to said shield movement mechanism and said electronic control unit such that movement of said shields results in a voltage value change in said potentiometer that is read by said electronic control unit; and
said electronic control unit including a visual readout representative of said change in voltage value.

17. The windrower of claim 16, wherein:
said shield movement mechanism further includes a bell crank affixed to said electric motor and said potentiometer is connected to said bell crank.

18. The windrower of claim 17, wherein:
said visual readout is in the form of a bar graph.

19. The windrower of claim 18, wherein:
said potentiometer is connected to said hell crank.

20. The windrower of claim 19, further including:
said respective rear ends of said shields are pivotably connected to said bell crank by first and second transfer rods.
